(19) United States
(12) Patent Application Publication
(10) Pub. No.: US 2005/0194775 A1
(43) Pub. Date: Sep. 8, 2005

(54) Axially adjustable steering spindle and method of making a steering spindle

(75) Inventors: Christian Bastein, Neu-Wulmstorf (DE); Fred Eggers, Buxtehude (DE); Holger Kittler, Hamburg (DE); Joerk Tatulinski, Hamburg (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 11/063,617

(22) Filed: Feb. 24, 2005

(30) Foreign Application Priority Data
Feb. 25, 2004 (DE) 10 2004 009 188.9

(51) Int. Cl. B62D 1/18

(52) U.S. Cl. 280/775

(57) ABSTRACT

An adjustable steering spindle for a motor vehicle includes a steering spindle hub and a steering spindle shaft. The steering spindle shaft is moveably mounted in the steering spindle hub in the axial direction, and the steering spindle hub is rigidly connected to the steering spindle shaft rotationally. The spindle further includes a locking device that limits shape-lockingly an axial movement of the steering spindle shaft in the spindle hub, which movement elongates the steering spindle in the axial direction.

This application claims the priority of German Patent Document No. 102004009 188.9, filed Feb. 25, 2004, the disclosure of which is expressly incorporated by reference herein.

### BACKGROUND AND SUMMARY OF THE INVENTION

The invention relates to an adjustable steering spindle for a motor vehicle with a steering spindle hub and a steering spindle shaft, and to a method of making a steering spindle. The steering spindle shaft is moveably mounted in the steering spindle hub in the axial direction; and the steering spindle hub is connected rotationally rigid to the steering spindle shaft.

DE 26 10 139 discloses a steering spindle, which can be adjusted in the axial direction and has an axially adjustable steering shaft. The steering shaft carries the steering wheel and engages with the steering gear. The steering shaft is mounted rotationally rigid, but axially slidable in a steering spindle hub or a steering shaft sleeve. The steering spindle is enveloped by an encasing tube, which has two telescope-like parts in the form of an outer steering column tube and an inner guide tube. The two tubes can be secured relative to each other by means of a clamp connection. When the clamp connection is disconnected, the two tubes can be slid axially head-on by sliding the steering spindle. The clamp connection has a threaded pin, pointing radially to the longitudinal axis of the steering spindle. The threaded pin is affixed to the outer steering column tube in the longitudinal direction of the steering spindle and assigned to an oblong slot in the guide tube. The threaded pin can be secured in the axial direction in relation to the guide tube by means of an externally mounted hand wheel.

One object of the present invention is to design and arrange a steering spindle in such a manner that it is designed more reliably, is simpler to mount and simultaneously smaller with a decrease in weight.

The invention achieves this object by providing a steering spindle that has a locking device that limits shape-lockingly a movement of the steering spindle shaft that elongates the steering spindle in the axial direction.

In this way the goal is reached that the steering spindle shaft cannot be pulled out of the steering spindle hub. When components fail, the separation of the steering spindle is prevented. Furthermore, this type of locking mechanism facilitates the assembly, because during installation the steering spindle shaft cannot slide out of the steering spindle hub irrespective of the manipulation.

In addition, it is advantageous that the steering spindle shaft has at least one stop and that the locking device is assigned to the steering spindle hub. In the area of the stop, the steering spindle shaft has an outer diameter that is larger than the inner diameter of the locking device. In this way the goal is reached that the locking mechanism is integrated directly between the steering spindle hub and the steering spindle shaft. The overall size of the steering spindle is not significantly larger than a steering spindle without a locking device.

Another possibility, according to a further development, is that the locking device is designed by deforming the steering spindle hub. This method of attaching a locking device is the simplest, most economical and makes it possible to redesign, according to the invention, any conventional steering spindle with only one additional processing step.

Furthermore, it is advantageous that the locking device is affixed to the steering spindle hub as a separate component and that the stop of the steering spindle shaft can be affixed directly to the locking device. In this way the goal is reached that the steering spindle hub is not deformed, but rather is fitted to receive a separate locking device. In the simplest case this is done with a thread or with a borehole for a pin or splint.

In addition, it is also advantageous that the steering spindle hub is designed hollow and has inner teeth and that the steering spindle shaft has outer teeth. The inner teeth mesh with the outer teeth; and/or the outer teeth are subdivided into at least two teeth segments in the axial direction. This type of rotationally rigid connection has proven to be advantageous with respect to security and simple fabrication. This type of rotational connection is maintenance free.

Finally, a preferred embodiment of the inventive solution provides that the stop of the steering spindle shaft is formed by way of the outer teeth. In this way the goal is reached that a component that is necessary for the locking mechanism already exists from the start in conventional steering spindles. The outer flanks of the outer teeth form together with the locking device the inventive positive-engagement.

It is of prime importance for the present invention that the steering spindle shaft is at least partially enveloped by the locking device and/or that the locking device is designed as a part of the mounting in the radial direction. In this way the goal is reached that with a suitable reduction of the diameter of the locking device, the steering spindle shaft is mounted in the locking device simultaneously for the inventive positive-engagement with the stop. To this end it is advantageous that a seal for the lubricant in the steering spindle hub is introduced into the locking device, which is designed as the bearing.

In connection with the inventive design and arrangement it is advantageous that the locking device or the steering spindle hub has at least one rolling, an impression or tapering, pointing inwardly in the radial direction. In this way the goal is reached that there is no need for any additional material input for forming the locking device. Preferably three impressions, which point inwardly in the radial direction, are distributed over the periphery. The impressions are for the case that the outer teeth form the stop, and are arranged and dimensioned in such a manner that at least one tooth engages with one impression.

Furthermore, it is advantageous that the locking device or the steering spindle hub has at least one pin, splint or rivet. In conformity with the impressions, preferably three pins, which are distributed over the periphery, are arranged in the radial direction in alignment with the teeth of the outer teeth. The splint is inserted preferably into a borehole, which runs as a secant relative to the peripheral line of the steering spindle hub. The splint is arranged correspondingly perpendicularly to the radial direction and perpendicularly to the axial direction.

In addition, it is advantageous that the locking device is formed by at least one ring or one sleeve and that the sleeve is connected at least shape-lockingly to the steering spindle hub. In this way the goal is reached that the locking device is formed by attaching a separate component. This sleeve is screwed in an advantageous way to the steering spindle hub or is inserted or pressed into the steering spindle hub. For this type of connection inner and outer sleeves can be used. The sleeves for insertion are preferably slotted because of the requisite change in diameter. Similarly a two-part sleeve for mounting on the steering spindle hub can be used.

Other objects, advantages and novel features of the present invention will become apparent from the following detailed description of the invention when considered in conjunction with the accompanying drawings.

### BRIEF DESCRIPTION OF THE DRAWINGS

FIG. 1 is a sectional view of a steering spindle with a tapering as the locking device.

FIG. 2 depicts a detail of a steering spindle with a rolling as the locking device.

FIG. 3 depicts a detail of a steering spindle with a tapering as the locking device.

FIG. 4 depicts a detail of a steering spindle with an impression as the locking device.

FIG. 5 depicts a detail of a steering spindle with a pin as the locking device.

FIG. 6 depicts a detail of a steering spindle with a sleeve with an outer thread as the locking device.

FIG. 7 depicts a detail of a steering spindle with a sleeve with an inner thread as the locking device.

FIG. 8 depicts a detail of a steering spindle with a sleeve with a snap lock element as the locking device.

FIG. 9 depicts a detail of a steering spindle with a two-part sleeve with a snap lock element as the locking device.

### DETAILED DESCRIPTION OF THE DRAWINGS

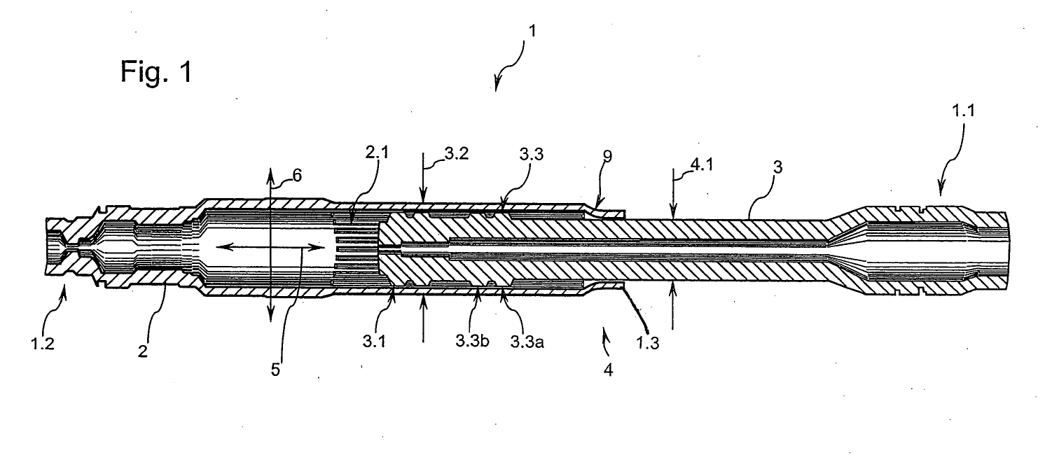

FIG. 1 depicts a steering spindle 1 with a tapering 9 as the locking device 4. The steering spindle 1 includes a head 1.1 and a foot 1.2. Connected to the head 1.1 is a steering wheel, which is not illustrated. The foot 1.2 of steering spindle 1 is connected to a steering gear.

The steering spindle 1 comprises a steering spindle hub 2 and a steering spindle shaft 3, received by means of the steering spindle hub 2. Both the steering spindle hub 2 and the steering spindle shaft 3 are designed as a hollow shaft.

The steering spindle shaft 3 can be slid in the axial direction 5 in the spindle hub 2 and is mounted in the steering spindle hub 2 in the radial direction 6. The steering spindle hub 2 and the steering spindle shaft 3 are connected together rotationally rigid by way of teeth. The teeth are formed by the inner teeth 2.1 of the steering spindle hub 2 and by the outer teeth 3.3 of the steering spindle shaft 3. The inner teeth 2.1 mesh with the outer teeth 3.3 to form a rotationally rigid connection.

To secure the steering spindle 1, i.e. to secure the steering spindle shaft 3 shape-lockingly against pulling out of the steering spindle hub 2, the steering spindle hub 2 includes a locking device 4 on an open side 1.3 of the steering spindle hub 2 that lies opposite the foot 1.2. In addition, the steering spindle shaft 3 includes a stop 3.1, which slides or rather strikes against the locking device 4 when the steering spindle shaft 3 is pulled out. To this end, an inside diameter 4.1 of the locking device 4 is designed so as to be smaller than an outside diameter 3.2 of the stop 3.1 of the steering spindle shaft 3.

The stop 3.1 is formed, according to FIG. 1, by the outer teeth 3.3. The outer teeth 3.3 are subdivided into several teeth rings 3.3a, 3.3b. In this embodiment the outermost teeth segment 3.3a forms the inventive stop 3.1.

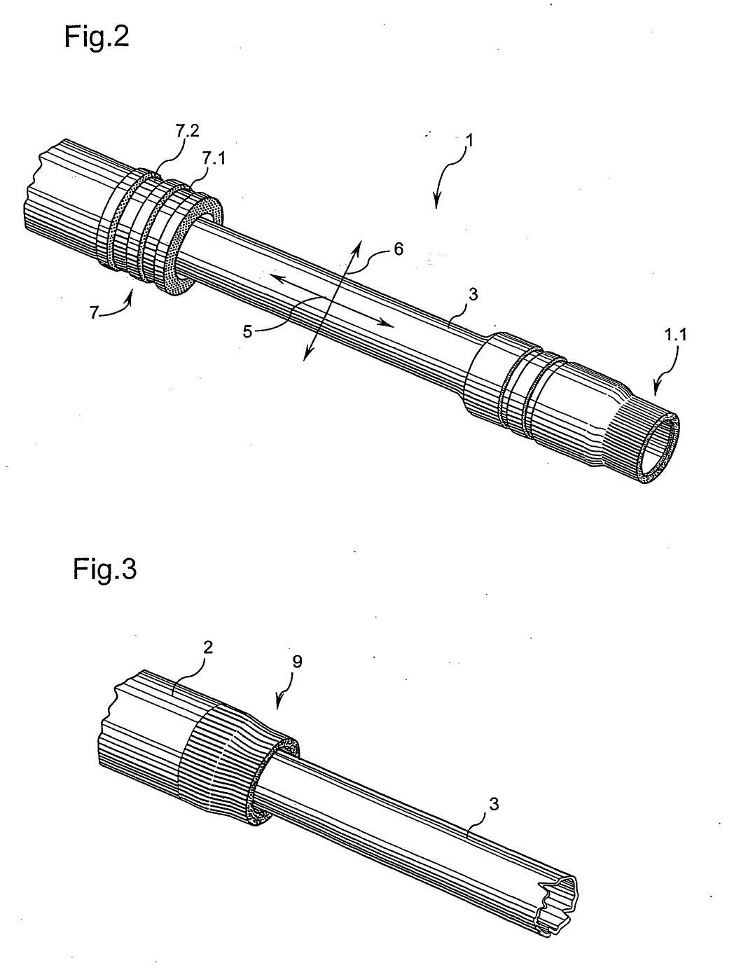

The locking device 4 can be formed by the steering spindle hub 2 itself or by a component fastened to the steering spindle hub 2. An inventive selection of locking devices 4 is depicted in FIGS. 2 to 9 and described below.

FIG. 2 depicts a locking device 4, which is formed by a rolling 7 of the steering spindle shaft 3. The rolling 7 is made in a cold forming process and has two grooves 7.1, 7.1′, which encircles the steering spindle shaft 3. The grooves 7.1, 7.1′ make it possible to decrease the inside diameter 4.1 of the locking device 4 or rather the steering spindle hub 2, so that the outer teeth 3.3 engage first with the groove 7.1 when the steering spindle shaft 3 is pulled out. The second groove 7.1 ′ serves for security and serves only in the exceptional case as a stop 3.1.

In addition to the function of the stop 3.1, the locking device 4 serves to guide the steering spindle shaft 3 in the radial direction 6. In the embodiment, according to FIG. 2, the rolling 7 allows a commensurate play between the grooves 7.1, 7.1′ and the steering spindle shaft 3.

In FIG. 3 the locking device 4, according to FIG. 1, is designed as a tapering 9. In this embodiment, too, the locking device 4 does not have a separate component. The locking device 4 is formed by cold forming the steering spindle hub 2.

In principle it is provided that the steering spindle hub 2 is sealed. To this end a sealing ring is provided, as a function of the design, between the locking device 4 or rather the steering spindle hub 2 and the steering spindle shaft 3. The sealing ring may be adapted to match the shape of the locking device 4.

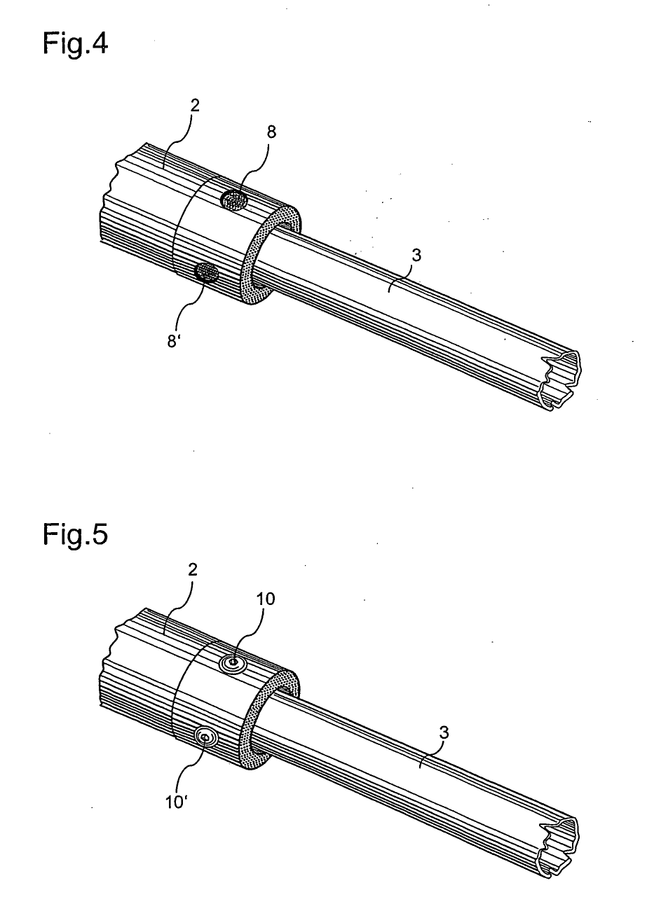

In FIG. 4, the locking device 4 is formed by three impressions 8, 8′, of which only two are illustrated. According to the embodiments of FIGS. 2 and 3, the impressions 8, 8′ are cold pressed and can serve to mount the steering spindle shaft 3 in the radial direction 6. Upon being pulled out, the steering spindle shaft 3 engages with the impressions 8, 8′.

According to FIG. 5, the locking device 4 is designed as a separate component. The component comprises several pins 10, 10′, which are inserted into the steering spindle hub 2 in the radial direction 6 in the edge region of the steering spindle hub 2. In the simplest embodiment the pins 10, 10′ are designed as tension bolts, against which the stop 3.1 of the steering spindle shaft 3 slides.

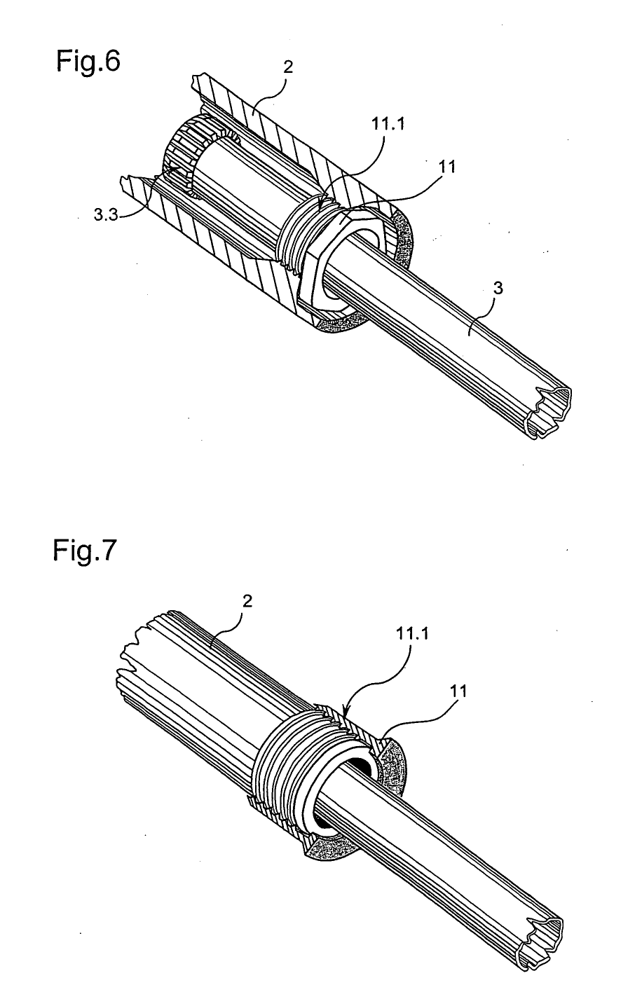

In FIG. 6 the locking device 4 is designed as a separate component. It is formed by a sleeve 11, which has an outer thread 11.1 and is screwed to the steering spindle hub 2. The sleeve 11 forms, according to the invention, the securing mechanism for the stop 3.1 or rather for the outer teeth 3.3 of the steering spindle shaft 3.

FIG. 7 shows a sleeve 11 with an inner thread 11.1. According to the embodiment of FIG. 4, the sleeve 11 is screwed together with the steering spindle hub 2 and forms a securing mechanism.

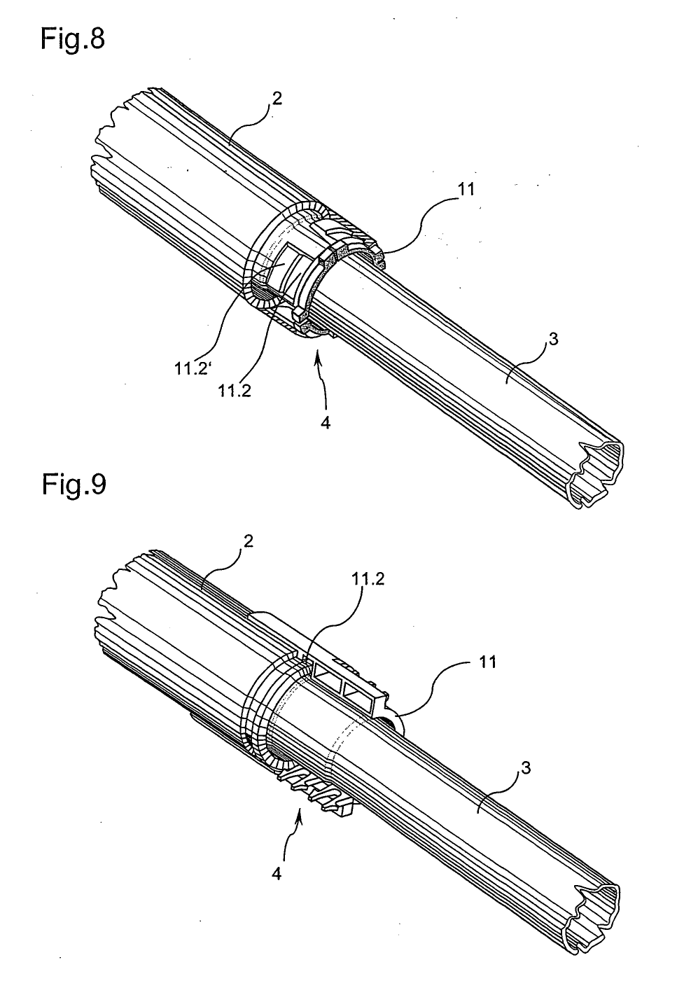

In FIGS. 8 and 9 the locking device 4 is designed as a sleeve 11 and is connected together with the steering spindle hub 2 as a separate component by way of snap lock elements 11.2, 11.2′.

According to FIG. 8, the sleeve 11 is slotted and is thus flexible in the radial direction 6 or rather diameter. In the mounted state the sleeve 11 is disposed inside the steering spindle hub 2. The snap lock elements 11.2, 11.2′ engage in the radial direction 6 outwardly with the steering spindle hub 2. For assembly purposes the sleeve 11 is inserted into the steering spindle hub 2 in the axial direction. In the mounted state the sleeve 11 forms the locking device 4 and simultaneously a guide for the steering spindle shaft 3 in the radial direction 6. The snap lock elements 11.2, 11.2′ are designed in such a manner that they engage self-lockingly with the corresponding recesses in the steering spindle hub 2.

The sleeve 11, according to FIG. 9, is designed as two parts and is mounted from the outside on the steering spindle hub 2. The sleeve 11 exhibits a snap lock element 11.2 in the form of an encircling leg. In the mounted state of the sleeve 11 the leg engages with a similarly encircling groove 2.2 on the outside of the steering spindle hub 2. The two-part sleeve 11 is connected as one piece by way of the self-locking snap locks. Even the sleeve 11, according to FIG. 9, forms in the mounted state the locking device 4 and is simultaneously a guide for the steering spindle shaft 3 in the radial direction 6.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. An adjustable steering spindle for a motor vehicle, comprising:
a steering spindle hub;
a steering spindle shaft, where the steering spindle shaft is moveably mounted in the steering spindle hub in the axial direction, and wherein the steering spindle hub is rigidly connected to the steering spindle shaft rotationally; and
a locking device that limits shape-lockingly an axial movement of the steering spindle shaft in the spindle hub, which movement elongates the steering spindle in the axial direction.

2. The spindle of claim 1, wherein the steering spindle shaft includes at least one stop that has an outer diameter, wherein the locking device is connected to the steering spindle hub and has an inner diameter, and wherein the outer diameter of the stop is larger than the inner diameter of the locking device.

3. The spindle of claim 2, wherein the locking device is formed by deforming the steering spindle hub.

4. The spindle of claim 2, wherein the locking device is affixed as a separate component to the steering spindle hub and wherein the stop of the steering spindle shaft can be affixed directly on the locking device.

5. The spindle of claim 4, wherein the steering spindle hub is hollow and includes inner teeth, wherein the steering spindle shaft includes outer teeth, wherein the inner teeth mesh with the outer teeth, and wherein the outer teeth have at least two teeth segments arranged relative to each other in the axial direction.

6. The spindle of claim 5, wherein the stop of the steering spindle shaft includes the outer teeth.

7. The spindle of claim 6, wherein the steering spindle shaft is at least partially enveloped by the locking device, and wherein the locking device is designed as a part of the mounting in the radial direction.

8. The spindle of claim 7, wherein the locking device or the steering spindle hub has at least one rolling, an impression or radially inward tapering.

9. The spindle of claim 8, wherein the locking device or the steering spindle hub has at least one pin, splint or rivet.

10. The spindle of claim 9, wherein the locking device is formed by at least one ring or one sleeve and wherein the sleeve is connected at least shape-lockingly to the steering spindle hub.

11. The spindle of claim 1, wherein the locking device is formed by deforming the steering spindle hub.

12. The spindle of claim 1, wherein the locking device is affixed as a separate component to the steering spindle hub and wherein the stop of the steering spindle shaft can be affixed directly on the locking device.

13. The spindle of claim 1, wherein the steering spindle hub is hollow and includes inner teeth, wherein the steering spindle shaft includes outer teeth, wherein the inner teeth mesh with the outer teeth, and wherein the outer teeth have at least two teeth segments arranged relative to each other in the axial direction.

14. The spindle of claim 13, wherein the stop of the steering spindle shaft includes the outer teeth

15. The spindle of claim 1, wherein the steering spindle shaft is at least partially enveloped by the locking device, and wherein the locking device is designed as a part of the mounting in the radial direction.

16. The spindle of claim 1, wherein the locking device or the steering spindle hub has at least one rolling, an impression or radially inward tapering.

17. The spindle of claim 1, wherein the locking device or the steering spindle hub has at least one pin, splint or rivet.

18. The spindle of claim 1, wherein the locking device is formed by at least one ring or one sleeve and wherein the sleeve is connected at least shape-lockingly to the steering spindle hub.

19. A method for making an adjustable steering spindle for a motor vehicle, comprising the steps of:
moveably mounting a steering spindle shaft of the adjustable steering spindle in a steering spindle hub of the adjustable steering spindle in the axial direction;
rigidly connecting the steering spindle hub to the steering spindle shaft rotationally; and
providing a locking device that limits shape-lockingly an axial movement of the steering spindle shaft in the spindle hub, which movement elongates the steering spindle in the axial direction.
